(19) United States
(12) Patent Application Publication
(10) Pub. No.: US 2023/0151875 A1
(43) Pub. Date: May 18, 2023

(54) DRIVE SYSTEM ARCHITECTURE FOR IMPROVED MOTOR EFFICIENCY

(71) Applicant: GM GLOBAL TECHNOLOGY OPERATIONS LLC, Detroit, MI (US)

(72) Inventors: Shawn H. Swales, Canton, MI (US); Chi Teck Lee, Novi, MI (US); Alan G. Holmes, Clarkston, MI (US); Hai Xu, Northville, MI (US); Venu Gopal Ganti, Troy, MI (US); Avinash Singh, Sterling Heights, MI (US)

(73) Assignee: GM GLOBAL TECHNOLOGY OPERATIONS LLC, Detroit, MI (US)

(21) Appl. No.: 17/455,224

(22) Filed: Nov. 17, 2021

(51) Int. Cl. F16H 3/32; B60K 1/00

(52) U.S. Cl. CPC F16H 3/32; B60K 1/00; B60K 2001/001; F16H 2200/0021

(57) ABSTRACT

Motor driven systems with optimized performance and efficiency are provided. A drive system includes a motor and a gear system coupled with the motor by a shaft. The gear system includes a pair of input gears disposed on the shaft, and a pair of transfer shafts including transfer gears meshing with the input gears. The gear system is configured to cancel axial, radial and/or tangential forces for minimized net force at the shaft.

### INTRODUCTION

The present disclosure generally relates to motor driven systems and more specifically, to drive systems with gear architectures providing desired and optimized performance by leveraging high speed motor input with minimized driveline origin loss inducing loads.

Motor driven systems of apparatus such as vehicles and other equipment and machinery, provide a motive force/torque for a variety of purposes. In applications such as a driveline of an electrified vehicle, power for the motor is at a premium and is preferably conserved. When employing relatively high speed motors, any added loads on the motor shaft tend to significantly increase power consumption leading to reduced operational range of the vehicle. In other various applications, added loads from the driven system may lead to a need to oversize the motor and/or to employ heavier bearings. Any added weight in battery powered vehicle applications may also lead to reduced range and so is preferably avoided.

In a number of applications, a motor may be coupled to the driven load through a gearing arrangement that increases or reduces rotational speed and torque. The gearing arrangement may take a variety of forms and generally, the moving parts include gears (simple or planetary), shafts and bearings. Any moving mechanical system has inefficiencies that arise from sources such as friction and other generated forces. Bearings and lubricants are often employed to reduce friction, increasing efficiency and performance while reducing wear. As the desire to further reduce inefficiencies increases, such as in battery powered vehicle applications, additional improvements would be beneficial.

Accordingly, it is desirable to provide motor driven systems for a variety of applications that result in appropriate performance characteristics such as torque/force requirements, and that provide desired levels of efficiency at minimized cost. Furthermore, other desirable features and characteristics of the present invention will become apparent from the subsequent detailed description and the appended claims, taken in conjunction with the accompanying drawings and the foregoing technical field and background.

### SUMMARY

Systems are provided for delivering power through a drive system with desirable performance characteristics such as operating a motor at high efficiency. In a number of embodiments, a drive system includes a motor and a gear system coupled with the motor by a shaft. At least one input gear is disposed on the shaft. One transfer shaft includes a transfer gear meshing with the input gear(s). Another transfer shaft includes an additional transfer gear meshing with the input gear(s). The gear system is configured to cancel axial forces at the shaft to avoid loads on the motor.

In additional embodiments, two input gears are opposite handed helix gears configured to cancel the axial forces at the shaft. The gear system is also configured to cancel at least one of radial and tangential forces

In additional embodiments, an output shaft carries a pair of output gears that are helix gears with opposite handed helix angles.

In additional embodiments, an additional pair of transfer gears are disposed on the transfer shafts and mesh with the output gears. The additional transfer gears are configured to cancel radial and tangential forces of the transfer gears and the output gears.

In additional embodiments, one of the input gears and one of the output gears have common handed helix angles, and the other of the input gears and the other of the output gears have different common handed helix angles.

In additional embodiments, one of the input gears and one of the output gears have helix angles defining a ratio of tangents approximately equal to a ratio of pitch diameters of two of the transfer gears on opposite transfer shafts.

In additional embodiments, bearings disposed on the transfer shaft(s), are configured to allow axial motion of the transfer shaft(s).

In additional embodiments, four pairs of meshing gears are included in the gear system. The output shaft carries a pair of output gears. The four pairs of meshing gears include one input gear meshing with a first of the transfer gears, the other input gear meshing with a second of the transfer gears, a third of the transfer gears meshing with one of the output gears and a fourth of the transfer gears meshing with the other output gear.

In additional embodiments, two transfer shafts are coaxial. One transfer shaft is a hollow shaft with a portion of the other transfer shaft extending through the hollow shaft.

In additional embodiments, an output shaft carries a pair of output gears. At least one output gear is a helix gear with a first helix angle of a first magnitude. At least one input gear is a helix gears with a second helix angle of a second magnitude that differs from the first magnitude enabling self-correction of force generation in the drive system.

In a number of additional embodiments, a drive system includes a motor and an input shaft driven by the motor that rotates about an input axis. A gear system is coupled with the motor by the input shaft, and includes first and second input gears disposed on the input shaft. A first transfer shaft includes a first transfer gear meshing with the first input gear, and a second transfer shaft includes a second transfer gear meshing with the second input gear. The first transfer gear and the first input gear include structures configured to cancel at least one of axial, radial and tangential forces of the second transfer gear and the second input gear at the input shaft. The first transfer shaft rotates about a first transfer axis and the second transfer shaft rotates about a second transfer axis. The input axis, the first transfer axis, and the second transfer axis all lie approximately in a common plane.

In additional embodiments, the first and second input gears comprise opposite handed helix gears with helix angles of a common magnitude and are configured to cancel the axial forces at the input shaft.

In additional embodiments, an output shaft is disposed on an output shaft axis. A first output gear is disposed on the output shaft, and a second output gear is disposed on the output shaft. The output gears comprise helix gears with opposite handed helix angles, and the output shaft axis lies outside the common plane.

In additional embodiments, a third transfer gear is disposed on the first transfer shaft and meshes with the first output gear. A fourth transfer gear is disposed on the second transfer shaft and meshes with the second output gear. The first output gear and the second output gear have a common pitch diameter.

In additional embodiments, the first and second input gears comprise a first double helix arrangement on the input shaft, and the first and second output gears comprise a second double helix arrangement on the output shaft. The first input gear and the first output gear have first common handed helix angles. The second input gear and the second output gear have second common handed helix angles.

In additional embodiments, a first bearing is disposed on the first transfer shaft and a second bearing is disposed on the first transfer shaft. A third bearing supports the second transfer shaft, and a fourth bearing supports the second transfer shaft. The first and second bearings are configured to allow axial motion of the first transfer shaft, and the third and fourth bearings are configured to allow axial motion of the second transfer shaft.

In additional embodiments, four pairs of meshing gears are included in the gear system, and an output shaft carries a first output gear and a second output gear. The four pairs of meshing gears include the first input gear meshing with the first transfer gear, the second input gear meshing with the second transfer gear, a third transfer gear meshing with the first output gear and a fourth transfer gear meshing with the second output gear. A first power flow path is defined from the input shaft, through the first input gear to the first transfer gear, through the first transfer shaft, and through the third transfer gear to the first output gear and to the output shaft. A second power flow path is defined from the input shaft, through the second input gear to the second transfer gear, through the second transfer shaft, and through the fourth transfer gear to the output shaft.

In additional embodiments, an output shaft in included in the gear system. The first and second transfer shafts are disposed at equal offset angles relative to the output shaft.

In additional embodiments, first and second output gears are disposed on an output shaft. The first and second input gears have a first common pitch diameter. The first and second output gears have a second common pitch diameter. The first and second output gears comprise output helix gears with first helix angles of a first magnitude. The first and second input gears comprise input helix gears with second helix angles of a second magnitude. The first magnitude differs from the second magnitude enabling self-correction of force generation in the drive system.

In a number of other embodiments, a drive system includes a motor driving an input shaft. A gear system drives an output shaft and is coupled with the motor by the input shaft. The gear system includes first and second input gears disposed on the input shaft. A first transfer shaft includes a first transfer gear meshing with the first input gear, and a second transfer shaft includes a second transfer gear meshing with the second input gear. The first transfer gear and the first input gear are configured to cancel radial and tangential forces of the second transfer gear and the second input gear at the input shaft. The gear system includes at least one output gear on the output shaft, the at least one output gear coupled with at least one of the first and second transfer shafts through a third transfer gear. The first and second input gears comprise a first double helix gear arrangement on the input shaft.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of a vehicle with a drive system including a motor driven gear system, in accordance with various embodiments;

FIG. 2 is a schematic illustration of helix gears for the system of FIG. 1, in accordance with various embodiments;

FIG. 3 is a schematic diagram of part of the drive system of FIG. 1 with double helical first and second stages and two transfer shafts on two sides of the input shaft, in accordance with various embodiments;

FIG. 4 is an output end view schematic diagram of the motor and gear system of FIG. 3, in accordance with various embodiments;

FIG. 5 is a force diagram output end view for part of the drive system of FIG. 1, in accordance with various embodiments;

FIG. 6 is a schematic diagram for part of the drive system of FIG. 1 with alternate gear locations, in accordance with various embodiments;

FIG. 7 is a schematic diagram for part of the drive system of FIG. 1 with an alternate bearing arrangement, in accordance with various embodiments;

FIG. 8 is a schematic diagram for part of the drive system of FIG. 1 with a bearing between the input gears, in accordance with various embodiments;

FIG. 9 is a schematic diagram for part of the drive system of FIG. 1 with four transfer shafts, in accordance with various embodiments;

FIG. 10 is a schematic diagram for part of the drive system of FIG. 1 with transfer shafts on one side, in accordance with various embodiments;

FIG. 11 is a schematic diagram for part of the drive system of FIG. 1 with single helical output, in accordance with various embodiments; and

FIG. 12 is a schematic diagram for part of the drive system of FIG. 1 with alternate gear locations in a single helical output, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description.

For the systems disclosed herein, motor input is delivered to a load through a gear system with balanced axial, radial and/or tangential forces. Balancing the axial, radial and/or tangential forces reduces loads, such as those introduced by the gearing onto the motor, leading to optimal performance, reduced weight, and improved efficiency. In a number of embodiments, a pair of transfer shafts include transfer gears that mesh with input gears on an input shaft and gears that mesh with output gears on the output shaft. The transfer shafts may be physically disposed to balance radial forces on the input and/or output shafts, when desired. In embodiments, the gearing arrangement enables the transfer shafts to each have gears with opposite helix angles and therefore to impose axial thrust reactions on the input and the output shafts in opposite directions cancelling the axial forces on the motor and on the downstream driveline. Reference to cancel forces herein means avoiding, eliminating, negating and/or nullifying forces, fully, or at least partially. Axial forces may be canceled on select transfer shafts through the use of axially floating shafts via appropriate bearings to self-correct for variations. Two independent load paths from input to output may be provided through individual and/or double gear meshes. Specific helix angles and paired arrangements of the gears on the shafts optimize alignment and other aspects of operation of the gearing. Radial and/or tangential forces may be avoided or canceled, at least partially, so as to not cause loads on the motor shaft. Losses may be further reduced by locating the transfer shafts at or near opposite sides of the motor axis. Minimizing the axial, radial and/or tangential forces on the motor provides a number of benefits such as lower loads leading to reduced power consumption. In addition, lighter weight components such as bearing may be used to support the various shafts under lower loads. Friction losses may be minimized by balancing the loads and providing smoother quieter operation.

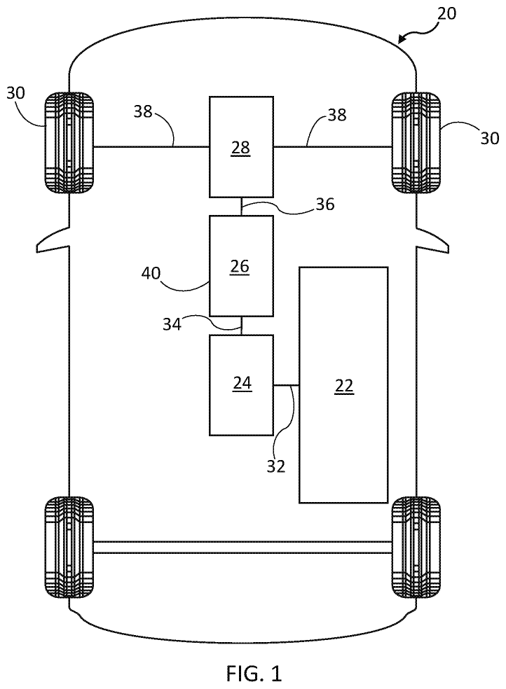

Referring to FIG. 1, an example application involves a vehicle 20 with a drive system 21 generally including a power supply 22, a motor 24, a gear system 26, and a differential 28, driving a pair of wheels 30. The power supply 22 is coupled with the motor 24 by a powerline 32. The motor 24 is coupled with the gear system 26 by a shaft 34 as an input shaft, and the gear system 26 is coupled with the differential 28 by a shaft 36 as an output shaft. The differential 28 is coupled with the wheels 30 by half-shafts 38. Accordingly, the motor 24 drives the wheels 30 through the drive system 21 including the gear system 26. Although the current embodiment is disclosed in the context of a vehicle 20, other applications will benefit from the balancing/reduction of forces and the mechanisms disclosed herein. Accordingly, the current disclosure is not limited to any specific application, but may be applied wherever reduced loads on a motor or otherwise on an upstream and/or downstream driveline is desirable.

In the current embodiment, the vehicle 20 may be any type of vehicle. The motor 24 may be operated by any means and in the current embodiment is an electric motor and accordingly, the power supply 22 may be an electrical power supply including a battery bank. As such, operation of the drive system 21 to propel the vehicle 20 may be limited by the storage capacity of power supply 22 leading to a limited electric operation range of the vehicle 20. Any reduction in power consumption is therefore beneficial in extending the range of the vehicle 20. The motor 24 may be configured to run at a variety of speeds including relatively high speeds which may compound any loads or losses introduced by any characteristics of, or inefficiencies in, the drive system 21. In a number of embodiments, the motor may spin at 10-25 times the number of revolutions per minute of the shaft 36 leaving the gear system 26, and so any effects introduced into the motor may be amplified by the speed. For example, the motor may operate up to 30,000 revolutions per minute and the output shaft may turn at a respective 1200 revolutions per minute. In other embodiments, any gearing ratio appropriate for the application may be used.

The gear system 26 may be any of a variety of configurations of gears and shafts. Mechanical excitation may occur during operation including from the mesh of the gears in the gear system 26 as a source. The excitation may lead to the transmission of forces and motions through the shafts and bearings and to the gear housing 40, which may in turn radiate noise. Accordingly, in the current embodiment the gear system 26 may employ helical gears for benefits including noise avoidance. Helical gears may run more smoothly and quietly than other types of gears such as spur gears with less noise and vibration being generated.

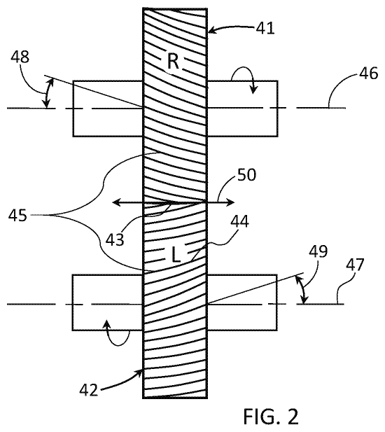

Example helical gears 41, 42 are illustrated in FIG. 2, to which reference is directed. The line of contact 43 of the helical gears 41, 42 is diagonal across the tooth trace 44. The helical gear teeth 45 are cut at angles 48, 49 to the rotational axes 46, 47 of the respective gear 41, 42 and follow a spiral path. The angle 48, 49 at which the gear teeth 45 are cut is referred to as the helix angle and may be either a right-hand helix (R) as in gear 41 or a left-hand helix (L) as in gear 42. When employing helix gears 41, 42 on parallel axes 46, 47, for the gears 41, 42 to mesh together, gear 41 has a right-hand helix and the meshing gear 42 has a left-hand helix. On both of the meshing gears 41, 42 the helix angles will be of the same magnitude. Helical gears, such as gears 41, 42 have a sliding contact of the meshing teeth 45. However, higher friction may accompany this sliding action leading to the generation of loads such as forces 50 that may result in drag on the system and a side thrust (axial force) may arise from the helix angles. Radial and tangential forces may also be generated as described below. The various forces, when not addressed by the approaches described herein, may transfer through the system to other components, such as the motor 24 creating undesirable loads and inefficiencies.

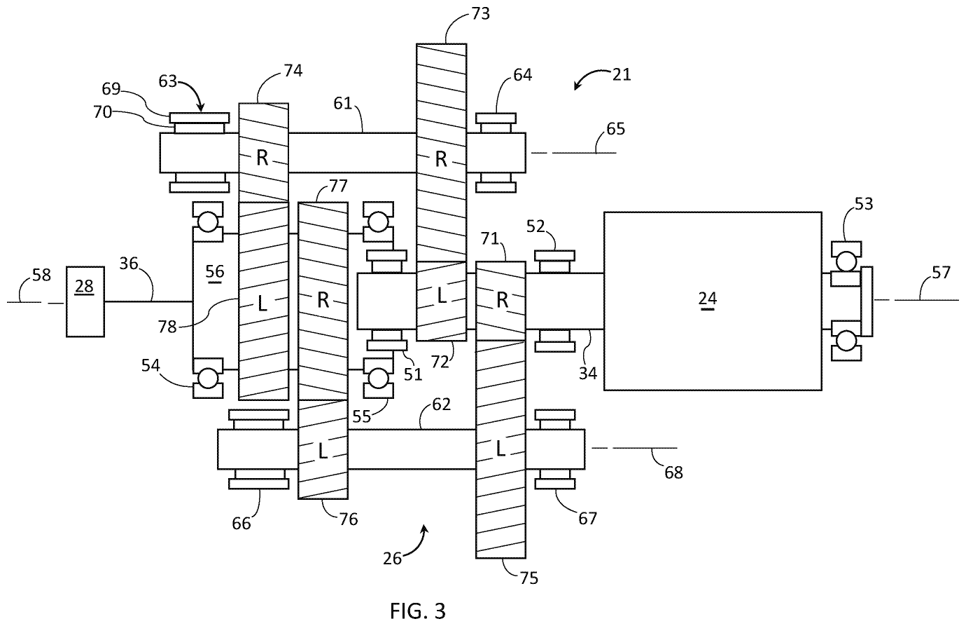

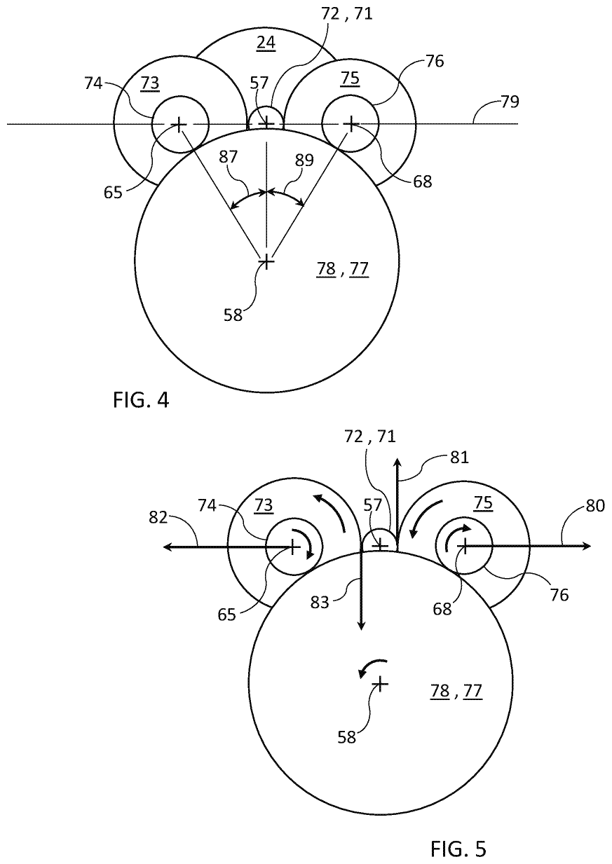

As shown in FIGS. 3 and 4, an example of the drive system 21 of the vehicle 20 includes the gear system 26 with the shaft 34 providing input from the motor 24, and with the shaft 36 delivering output to the differential 28. In this embodiment, the shafts 34 and 36 are disposed in a parallel relationship with one another, and disposed offset with the shaft 36 and located further back than the shaft 34 as viewed in the illustration of FIG. 3 and visible in the illustration of FIG. 4. The shaft 34 is supported by bearings 51-53 on an axis 57 and the shaft 36 is supported at least by bearings 54-55 on an axis 58. The bearings 54, 55 directly support a hub 56, which may be formed as part of, or connected with, the shaft 36.

The gear system 26 includes a pair of transfer shafts 61, 62. The transfer shaft 61 is supported by bearings 63, 64 and rotates about an axis 65, and the transfer shaft 62 is supported by bearings 66, 67 and rotates about an axis 68. The bearings 63-64 and 66-67 are of a configuration that allows the shafts 61, 62 to move, at least slightly, along their respective axis 65, 68. This axial movement enables the shafts 61, 62 to seek positions, such as in response to the force 50 and/or as a result of variations in cutting of the teeth 45, to assist in relieving the axial forces/thrust without transferring those to the motor 24 or to the differential 28. For example, the bearings 63-64 and 66-67 may be of the cylindrical or needle roller type with a sleeve/cup 69 and rollers 70. The gears 71-78 may be rigidly fixed to their respective shafts 34, 36, 61, 62 and the bearings 63-64 and 66-67 relieve the axial forces/thrust.

To transfer rotation, movement, and power from the shaft 34 to the shaft 36, a split power path is provided through the transfer shafts 61, 62 and through gears 71-78. In the current embodiment, all of the gears 71-78 are helical gears with meshing gears of opposite handed configuration so each meshing pair includes a right handed version (R) and a left handed version (L). In other embodiments, other gear types may be used. A first power flow path is provided from the shaft 34, through the gears 71 and 75, through the transfer shaft 62, through the gears 76 and 77, and to the shaft 36 at the hub 56. A second power flow path is provided from the shaft 34, through the gears 72 and 73, through the transfer shaft 61, and through the gears 74 and 78 to the shaft 36 at the hub 56.

Gears 71 and 72 are disposed on, and rotate with, the shaft 34 as an input shaft from the motor 24. Gears 73 and 74 are disposed on, and rotate with, the transfer shaft 61. Gears 75 and 76 are disposed on, and rotate with, the transfer shaft 62. Gears 77 and 78 are coupled and rotate with the shaft 36 as an output shaft. Gears 71 and 75 mesh with each other, are opposite handed relative to one another, and have helix angles of equal magnitude. Gears 72 and 73 mesh with each other, are opposite handed relative to one another, and have helix angles of equal magnitude. Gears 76 and 77 mesh with each other, are opposite handed relative to one another, and have helix angles of equal magnitude. Gears 74 and 78 mesh with each other, are opposite handed relative to one another, and have helix angles of equal magnitude. Gears 71 and 72 have a common pitch diameter. Gears 77 and 78 have a common pitch diameter. The gear system 26 may provide a reduction ratio between the shaft 34 to the shaft 36 of approximately 10:1 to 20:1. The rotational speed of the transfer shafts 61 and 62 may be approximately one-third that of the input shaft 34.

The gearing arrangement of FIGS. 3 and 4 provides balancing of the forces generated during operation of the gear system 26. For example, the gears 71 and 72 on the shaft 34 of the motor 24 have opposite handedness and helix angles of equal magnitude to result in a balancing of the generated axial forces. The two transfer shafts 61 and 62 are disposed on opposite sides of the shaft 34 provide radial balancing. As shown in FIG. 4, the lines of the axes 57, 65 and 68 are disposed in a common plane 79 (viewed on edge), with the axes 65 directly opposite the axis 68 across from the axis 57 for the balance. In other embodiments, the axes 65 and 68 may not be directly across the axis 57 from one another and may lie outside the plane 79, such as by a small angle deviating from the plane 79 or other angle as appropriate for the application. The transfer shafts 61 and 62 are disposed on axis 65 and 68 respectively, which lie at offset angles 87 and 89 relative to the axis 58 of the shaft 36. The offset angles 87 and 89 are optimized for balancing of forces on the drive system 21 and for packaging considerations. For example, the offset angels 87 and 89 have equal magnitudes and each has a sufficient magnitude for balancing optimization. Also, for example, the offset angles 87 and 89 are maintained at a relatively small magnitude for packaging considerations, while accommodating the gear ratios required.

Referring additionally to FIG. 5, force balancing is schematically shown. It will be appreciated that axial/thrust forces (not shown), will be directed into or out of the view and are balanced as described above. To assist in avoiding or canceling those axial forces, the gears 71, 72 are opposite handed. A radial force 80 is depicted at the axis 68 resulting from meshing gears 71 and 75. A tangential force 81 is depicted at the gear 75 resulting from meshing gears 71 and 75. A radial force 82 is depicted at the axis 65 resulting from meshing gears 72 and 73. A tangential force 83 is depicted at the gear 73, resulting from meshing gears 72 and 73. Forces on the shaft 36 and its gearing are not shown in this illustration. Because the gears 71 and 72 have the same number of teeth at common helix angles and common pitch diameters and the gears 73, 75 have the same number of teeth at common helix angles, the radial forces 80, 82 balance and cancel each other and the tangential forces 81, 83 balance and cancel each other, resulting on a net zero or near-zero force on the shaft 34 and at the axis 57 of the motor 24. A similar result may be accomplished at the axis 58 at the output to the differential 28.

To further optimize performance, including to minimize losses and loads on the motor 24, the gears 77 and 78 at the shaft 36 have opposite handed helix angles of equal magnitude and have a common pitch diameter. In addition, the gears 71 and 77 have common handed helix angles and the gears 72 and 78 have common handed helix angles. In addition, the gear 71 and the gear 77 have helix angle magnitudes with a ratio of tangents equal, or approximately equal to, a ratio of pitch diameters of the gears 75 and 76. Further, the offset angles 87 and 89 between the axis 58 and the transfer shafts 61, 62 for optimized for packaging and force reduction purposes. The helix angles of the gears 77, 78 have magnitudes that differ, by a number of degrees, from the helix angles of the gears 71, 72 providing an additional degree of freedom to self-correct for force generation in the drive system 21 and to avoid restriction. As a result, loads on the motor 24 and on the bearings 51-55 are minimized resulting in optimized performance with maximum efficiency, and enabling the use of smaller lighter weight components, for maximized vehicle range. Force generation in the drive system may occur, such as due to variations in manufacturing tolerances and/or inexact meshing or rotation. Examples include index error, wobble, eccentricity error, or other irregularities. For example, index error may arise due to the angular relationship of gear teeth between decks or planes. Wobble may occur under operating conditions of a shaft where a combination of support stiffness and shaft stiffness may cause movement from the shaft's center axis. Eccentricity may occur under operating conditions of a gear and its shaft where the center axis of the shaft in not concentric with the reference center axis of the gear.

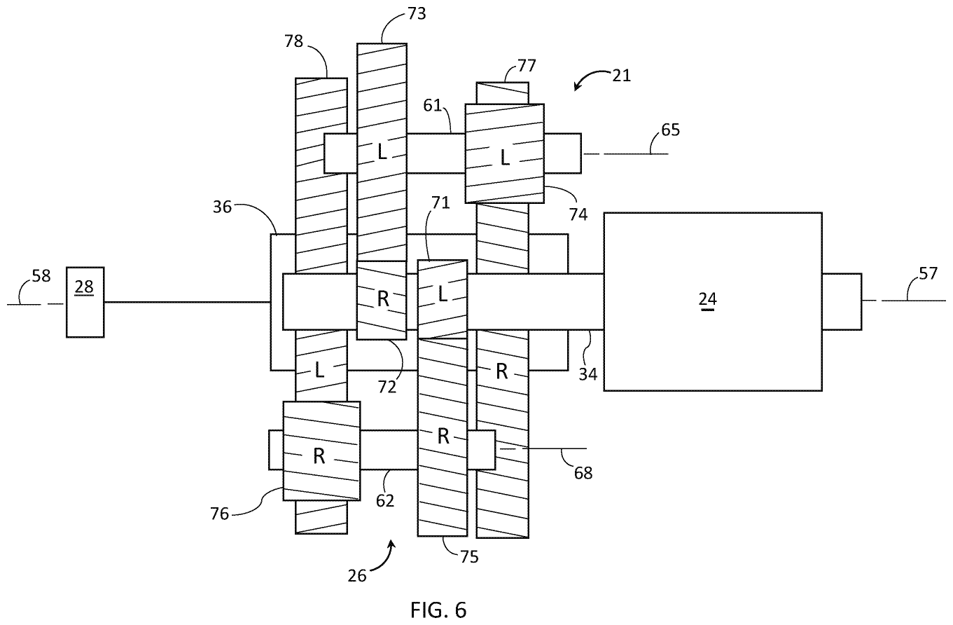

An alternate gear location arrangement is depicted in FIG. 6, with the shafts 34, 36 extending parallel to, and partially alongside each other. A double helix gear arrangement is provided on both the shafts 34, 36. In this example, the gears 71 and 72 are located axially between the gears 77 and 78. A zero, or near zero net thrust is provided through a combination of the shafts 34 and 36. The transfer shafts 61 and 62 are disposed on opposite sides of the shaft 34 and may be shorter than in the embodiment of FIG. 3, providing a more compact package, which may enable further weight reduction. Two power/load paths are provided through the gear system 26. The first power flow path is from the shaft 34, through the gears 71 and 75, through the transfer shaft 62, through the gears 76 and 78, to the shaft 36. The second power flow path is from the shaft 34, through the gears 72 and 73, through the transfer shaft 61, and through the gears 74 and 77 to the shaft 36. Balancing of forces in the axial, radial and tangential directions is accomplished similar to the embodiment of FIG. 3.

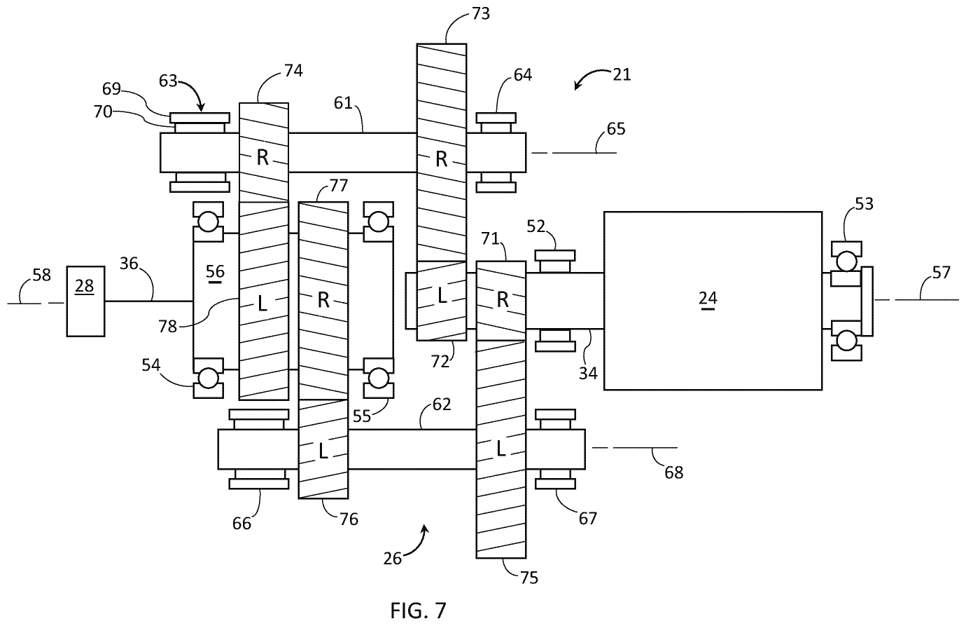

An alternate bearing arrangement is shown in the drive system 21 of FIG. 7. A double helix gear arrangement is provided on both the shafts 34, 36, similar to that of the embodiment of FIG. 3. The input shaft from the motor 24 is supported by bearings 52 and 53, with the bearing 51 of FIG. 3 is omitted. This bearing arrangement is enabled by balancing and reducing forces and results in the ability to use a shorter shaft 34. As a result, additional weight reduction is achieved.

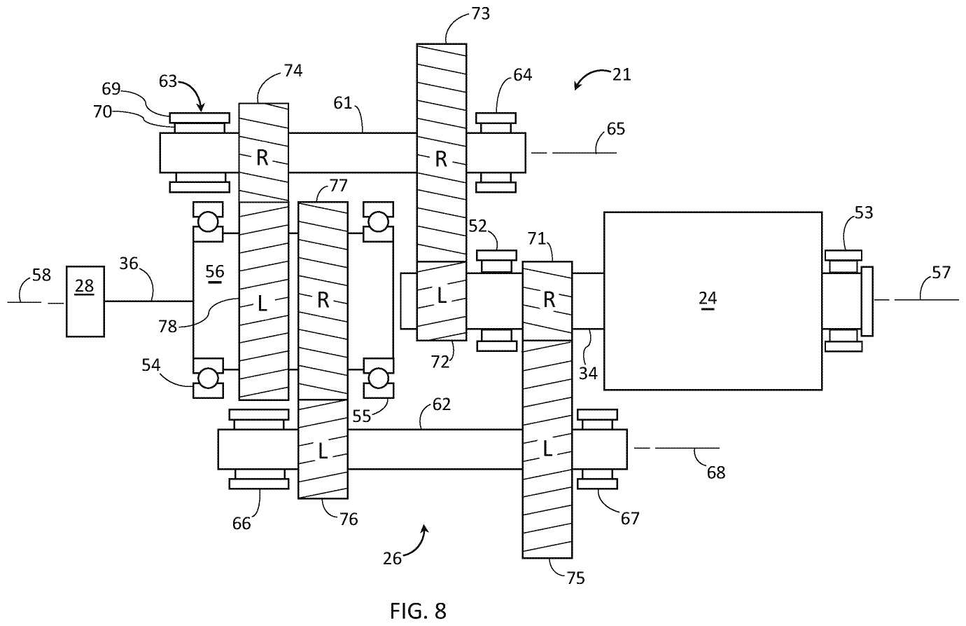

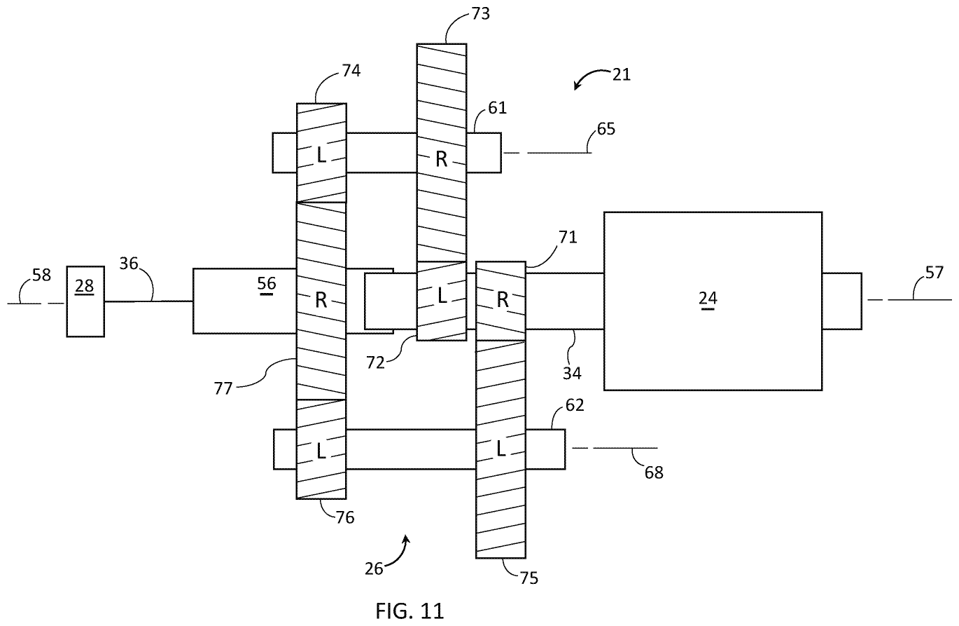

As illustrated in FIG. 8, in a gearing arrangement similar to that of FIG. 3, the bearing 52 is located on the input shaft between the input gears 71 and 72. This enables omitting the bearing 51 and shortening the input shaft 34, saving cost and weight. The bearings 52 and 53 are configured to allow the input shaft 34 to move axially to cancel axial forces at the motor 24. This arrangement of a floating input shaft 34 may be desirable in other embodiments to cancel forces, such as that of FIG. 11 where a single output gear 77 is used.

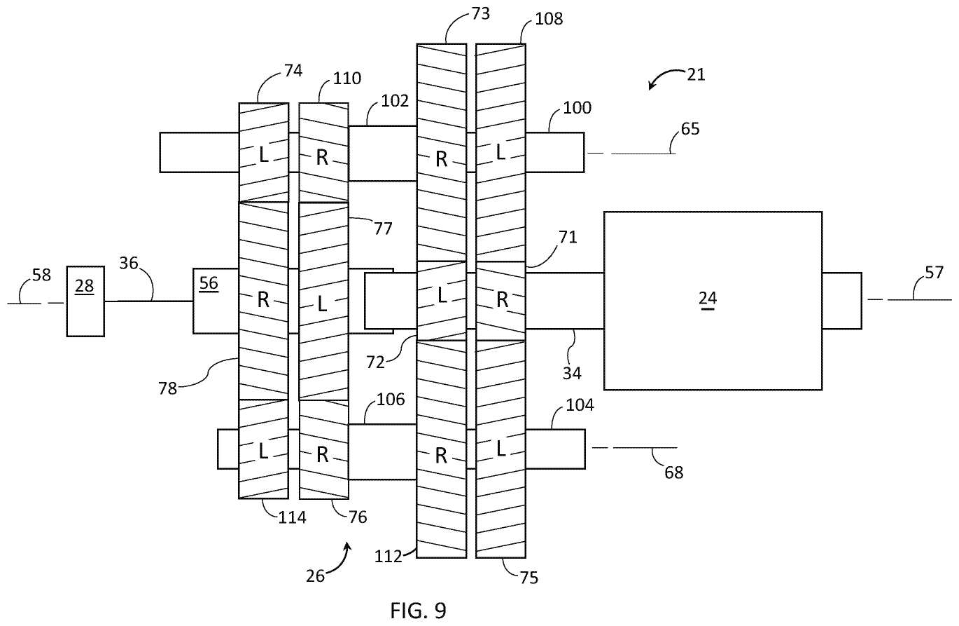

An alternative gear arrangement for the gear system 26 is illustrated in FIG. 9 with a total of eight meshing gear pairs. In this and following illustrations, the bearings and some other elements are omitted for simplicity. The shafts 34 and 36 are each in double meshing relationship with each of the transfer shaft axes 65 and 68. The axis 65 has coaxial shafts 100 and 102, with the shaft 102 being hollow so that the shaft 100 extends through the hollow interior of the shaft 102. Similarly, the axis 68 has coaxial shafts 104 and 106, with the shaft 106 being hollow so that the shaft 104 extends through the hollow interior of the shaft 106. Similar to the embodiment of FIG. 3, the shaft 34 includes two helical gears 71 and 72 and the shaft 36 includes two helical gears 77 and 78. The transfer shafts 100 and 102 carry four gears 108, 73, 110 and 74. The transfer shafts 104 and 106 carry four gears 75, 112, 76 and 114. The gears 108 and 74 are disposed on the shaft 100. The gears 73 and 110 are disposed on the shaft 102. The gears 75 and 114 are disposed on the shaft 104. The gears 112 and 76 are disposed on the shaft 106. The gears 73 and 108 are opposite handed, the gears 75, 112 are opposite handed, the gears 74 and 110 are opposite handed and the gears 76 and 114 are opposite handed. The result is four separate power flow paths through the gear system 26. A first power path is from the shaft 34 through the gears 71 and 75, through the transfer shaft 104, through the gears 114 and 78 and to the shaft 36 at the hub 56. A second power path is from the shaft 34 through the gears 71 and 108, through the transfer shaft 100, and through the gears 74 and 78 to the shaft 36 at the hub 56. A third power path is from the shaft 34, through the gears 72 and 73, through the transfer shaft 102, and through the gears 110 and 77 to the shaft 36 at the hub 56. A fourth power path is from the shaft 34, through the gears 72 and 112, through the transfer shaft 106, and through the gears 76 and 77 to the shaft 36 at the hub 56. Balancing of forces in the axial, radial and tangential directions is accomplished similar to the embodiment of FIG. 3. As a result of this gear arrangement, a higher level of balancing may be achieved by the additional offsetting gear arrangements. In addition, a higher torque carrying capacity may be provided and/or lighter weight gears may be used.

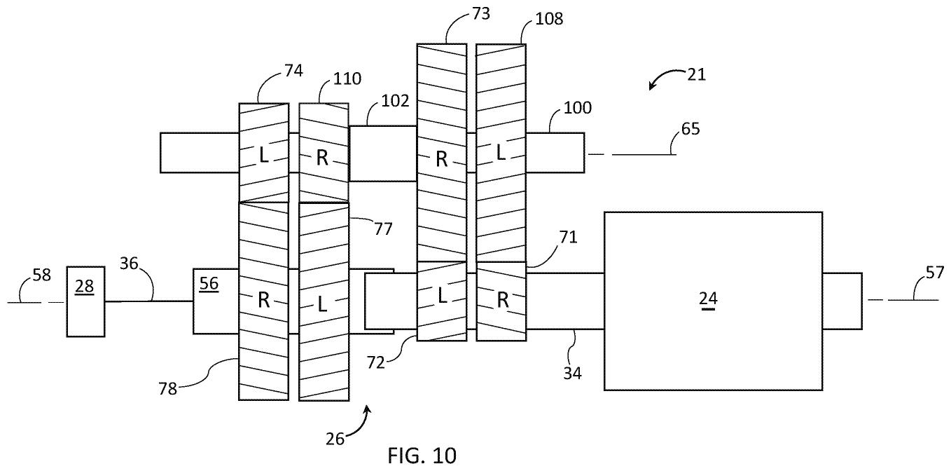

As illustrated in FIG. 10, an embodiment includes two transfer shafts 100 and 102 on the single axis 65, with both located on one side of the shaft 34 of the motor 24. The gears 71 and 72 are opposite handed from one another, as are the gears 77 and 78. As in the embodiment of FIG. 9, the axial forces at the gear set 72, 73 cancel and balance the forces at the gear set 71, 108. Similarly, the axial forces at the gear set 77, 110 cancel and balance the forces at the gear set 74, 78. In the embodiment of FIG. 10, providing transfer shafts on one side enables weight reductions and packaging space reductions over the embodiment of FIG. 9 and balances the axial forces to avoid loading the shaft 34 of the motor 24 to avoid associated losses. In addition, even with all of the gears rigidly mounted to their respective shafts, the bearings allow the shafts to move axially to adjust for varying loads as described above.

An embodiment as illustrated in FIG. 11 eliminates the gear 78 as compared to the embodiment of FIG. 3. The embodiment is a double helix input and single helix output with two transfer shafts 61, 62. The gears 74 and 76 both engage and mesh with the single gear 77 on the shaft 36. Eliminating the gear 78 reduces weight while balancing of axial, radial and tangential forces is provided at the shaft 34 by the gears 71, 72, 73 and 75. Accordingly, efficient operation of the motor is accomplished in a lighter lower cost approach.

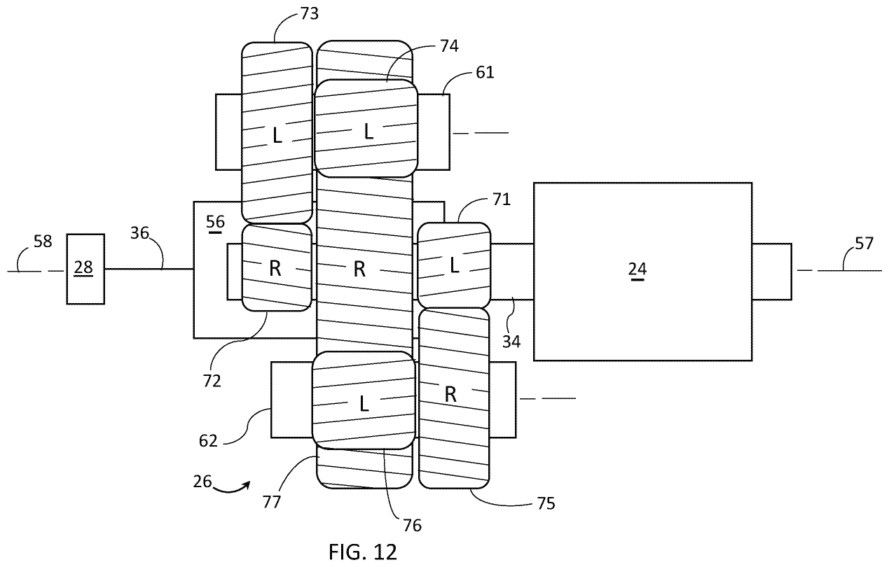

Another double helix input and single helix output with two transfer shafts embodiment is illustrated in FIG. 12. The shaft 34 to the motor 24 includes the two opposite handed helix gears 71 and 72. The shaft 36 to the differential 28 includes one helix gear 77, which is common handed with the gear 72. One power path through the gear system 26 is from the shaft 34 through the gear 71, the gear 75, the transfer shaft 62, the gear 76 and the gear 77 to the shaft 36. A second power path through the gear system 26 is from the shaft 34 through the gear 72, the gear 73, the transfer shaft 61, the gear 74 and the gear 77 to the shaft 36. Accordingly, the gear 77 is in both power paths. Balancing of axial, radial, and tangential forces is provided at the shaft 34 by the gears 71, 72, 73 and 75.

Accordingly, motor driven systems are provided that address axial, radial and tangential force balancing to reduce loads, including on the motor. Pairs of transfer shafts with gears engage double gears on the input (motor) shaft and/or output (differential) shaft. The transfer shafts may be arranged on opposite sides, or on a common side, of the input and/or output shafts to reduce net radial loading of the input and/or output shafts, especially the input shaft. Opposing input helix angles and opposing output helix angles are provided to eliminate/optimize total thrust on the transfer shafts. Transfer shafts may be mounted to allow axial movement, such as with cylindrical roller bearings, for example, to allow each shaft to seek the optimum axial location to accommodate input and output gearing with little or axial movement, such as between an electric traction motor and a differential drive to wheels through half-axles. In applications, the handedness of the helix angles of the gears in an embodiment may be modified. For example, in the embodiment of FIG. 11, the right and left helixes of the gears 71 and 72 may be swapped, and the helix hands of the remaining gears may be adjusted accordingly.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A drive system comprising:
a motor; and
a gear system coupled with the motor by a shaft, including at least one input gear disposed on the shaft, a first transfer shaft including a first transfer gear meshing with the at least one input gear, and a second transfer shaft including a second transfer gear meshing with the at least one input gear, wherein the gear system is configured to cancel, at least partially, axial forces at the shaft.

2. The drive system of claim 1, wherein the at least one input gear comprises first and second input gears comprising opposite handed helix gears configured to cancel the axial forces at the shaft.

3. The drive system of claim 2, comprising:
an output shaft;
a first output gear disposed on the output shaft; and
a second output gear disposed on the output shaft, wherein the first and second output gears comprise helix gears with opposite handed helix angles.

4. The drive system of claim 3, comprising a third transfer gear disposed on the first transfer shaft and meshing with the first output gear, and a fourth transfer gear disposed on the second transfer shaft and meshing with the second output gear, wherein the third transfer gear and the first output gear are configured to cancel radial and tangential forces of the fourth transfer gear and the second output gear.

5. The drive system of claim 3, wherein the first input gear and the first output gear have first common handed helix angles, and the second input gear and the second output gear have second common handed helix angles.

6. The drive system of claim 3, wherein the first input gear and the first output gear have helix angles defining a ratio of tangents approximately equal to a ratio of pitch diameters of the first transfer gear and the third transfer gear.

7. The drive system of claim 1, comprising a first bearing and a second bearing disposed on the first transfer shaft, wherein the first and second bearings are configured to allow axial motion of the first transfer shaft.

8. The drive system of claim 1, comprising four pairs of meshing gears and an output shaft carrying a first output gear and a second output gear, wherein the four pairs of meshing gears include a first input gear meshing with the first transfer gear, a second input gear meshing with the second transfer gear, a third transfer gear meshing with the first output gear and a fourth transfer gear meshing with the second output gear.

9. The drive system of claim 1, wherein the first and second transfer shafts are coaxial, and the second transfer shaft is a hollow shaft with a portion of the first transfer shaft extending through the hollow shaft.

10. The drive system of claim 1, comprising:
an output shaft;
a first output gear disposed on the output shaft; and
a second output gear disposed on the output shaft,
wherein the first and second output gears comprise output helix gears with first helix angles of a first magnitude,
wherein the at least one input gear comprises first and second input gears;
wherein the first and second input gears comprise input helix gears with second helix angles of a second magnitude,
wherein the first magnitude differs from the second magnitude enabling self-correction of force generation in the drive system.

11. A drive system comprising:
a motor;
an input shaft driven by the motor and rotating about an input axis; and
a gear system coupled with the motor by the input shaft, including first and second input gears disposed on the input shaft, a first transfer shaft including a first transfer gear meshing with the first input gear, and a second transfer shaft including a second transfer gear meshing with the second input gear, wherein the first transfer gear and the first input gear include structures configured to cancel axial forces of the second transfer gear and the second input gear at the input shaft,
wherein the first transfer shaft rotates about a first transfer axis and the second transfer shaft rotates about a second transfer axis,
wherein the input axis, the first transfer axis, and the second transfer axis lie approximately in a common plane.

12. The drive system of claim 11, wherein the first and second input gears comprise opposite handed helix gears with helix angles of a common magnitude and configured to cancel the axial forces at the input shaft.

13. The drive system of claim 11, comprising:
an output shaft disposed on an output shaft axis;
a first output gear disposed on the output shaft; and
a second output gear disposed on the output shaft, wherein the first and second output gears comprise helix gears with opposite handed helix angles,
wherein the output shaft axis lies outside the common plane.

14. The drive system of claim 13, comprising a third transfer gear disposed on the first transfer shaft and meshing with the first output gear, and a fourth transfer gear disposed on the second transfer shaft and meshing with the second output gear, wherein the first output gear and the second output gear have a common pitch diameter.

15. The drive system of claim 13, wherein:
the first and second input gears comprise a first double helix arrangement on the input shaft and the first and second output gears comprise a second double helix arrangement on the output shaft,
the first input gear and the first output gear have first common handed helix angles, and
the second input gear and the second output gear have second common handed helix angles.

16. The drive system of claim 11, comprising:
a first bearing disposed on the first transfer shaft;
a second bearing disposed on the first transfer shaft;
a third bearing supporting the second transfer shaft; and
a fourth bearing supporting the second transfer shaft,
wherein the first and second bearings are configured to allow axial motion of the first transfer shaft,
wherein the third and fourth bearings are configured to allow axial motion of the second transfer shaft.

17. The drive system of claim 11, comprising four pairs of meshing gears and an output shaft carrying a first output gear and a second output gear,
wherein the four pairs of meshing gears include the first input gear meshing with the first transfer gear, the second input gear meshing with the second transfer gear, a third transfer gear meshing with the first output gear and a fourth transfer gear meshing with the second output gear,
wherein a first power flow path is defined from the input shaft, through the first input gear to the first transfer gear, through the first transfer shaft, and through the third transfer gear to the first output gear and to the output shaft,
wherein a second power flow path is defined from the input shaft, through the second input gear to the second transfer gear, through the second transfer shaft, and through the fourth transfer gear to the output shaft.

18. The drive system of claim 11, comprising an output shaft of the gear system, wherein the first and second transfer shafts are disposed at equal offset angles relative to the output shaft.

19. The drive system of claim 11, comprising:
an output shaft;
a first output gear disposed on the output shaft; and
a second output gear disposed on the output shaft,
wherein the first and second input gears have a first common pitch diameter;
wherein the first and second output gears have a second common pitch diameter,
wherein the first and second output gears comprise output helix gears with first helix angles of a first magnitude,
wherein the first and second input gears comprise input helix gears with second helix angles of a second magnitude,
wherein the first magnitude differs from the second magnitude enabling self-correction of force generation in the drive system.

20. A drive system comprising:
a motor driving an input shaft; and
a gear system driving an output shaft and the gear system coupled with the motor by the input shaft, the gear system including first and second input gears disposed on the input shaft, a first transfer shaft including a first transfer gear meshing with the first input gear, and a second transfer shaft including a second transfer gear meshing with the second input gear, wherein the first transfer gear and the first input gear are configured to cancel radial and tangential forces of the second transfer gear and the second input gear at the input shaft,
wherein the gear system includes at least one output gear on the output shaft, the at least one output gear coupled with at least one of the first and second transfer shafts through a third transfer gear,
wherein the first and second input gears comprise a first double helix gear arrangement on the input shaft.
